(19) United States
(12) Patent Application Publication
(10) Pub. No.: US 2007/0268300 A1
(43) Pub. Date: Nov. 22, 2007

(54) INFORMATION MAP SYSTEM

(75) Inventors: Zhaoxia Jin (Janet), Shanghai (CN); John R. Hajdukiewicz, Minneapolis, MN (US); Yajun Zhang, Shanghai (CN)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/733,398

(22) Filed: Apr. 10, 2007

Related U.S. Application Data
(63) Continuation-in-part of application No. 11/438,788, filed on May 22, 2006.

(51) Int. Cl. G09G 5/00

(52) U.S. Cl. 345/581

(57) ABSTRACT

A map for displaying hierarchical or non-hierarchical information in a two dimensional format in a fixed space. The map may be used for displaying information about various entities of a complex arrangement for simultaneous viewing in one presentation or display. Examples of these entities may include controllers, plants and IO terminals. One form of representation may be in nested rectangles. Another form may be in sectors of circles. Other geometrical shapes or figures may used for a graphical presentation of the entities or components. Status of the entities may be indicated with a graphical pattern, color, shading, flickering, and/or other manner. Effort representations, filters, tabular displays, popups of enlarged or scalable portions of the map, layouts with space for other information, and quick access techniques for seeking data points may be incorporated in the map.

The invention is a continuation-in-part application of U.S. patent application Ser. No. 11/438,788, filed May 22, 2006. U.S. patent application Ser. No. 11/438,788, filed May 22, 2006, is hereby incorporated by reference.

### BACKGROUND

The present invention pertains to displays and particularly to displays of information. More particularly, the invention pertains to graphical rendering of technological information.

### SUMMARY

The invention is a version of two-dimensional map for simultaneously displaying complex information in one view.

### BRIEF DESCRIPTION OF THE DRAWING

FIG. 1 is a diagram of a conventional approach for displaying data;

FIG. 2a is a diagram of a rectangular map of the present invention;

FIG. 2b is a legend of graphics for the map;

FIG. 3 illustrates some techniques for indicating a status or change of status;

FIG. 4 illustrates an example approach for filtering terminals;

FIG. 5 illustrates a quick access approach to a scalable view of a rectangular map;

FIG. 6 shows a miniaturized view of a rectangular map in a layout having space for related information;

FIG. 7 shows a tabular view of data integrated with a rectangular map overview;

FIG. 8 shows a radial map;

FIG. 9 illustrates some techniques for indicating a status or change of status with a radial map;

FIG. 10 illustrates a quick access approach to a scalable view of a radial map;

FIG. 11 shows a miniaturized view of a radial map in a layout having space for related information;

FIG. 12 shows a tabular view of data integrated with a radial map overview;

FIG. 13 shows another version of the radial map; and

FIGS. 14a and 14b show a map view with a layout at just a point level of a project.

### DESCRIPTION

Some conventional approaches may graphically display data. When tens of thousands of data elements are displayed using conventional approaches, the regions of data points may become excessively small, and the visibility thereof lowered. Thus, the conventional approaches appear not suitable for distinguishing some important data elements such as tasks or areas not started, uncompleted and conflicted. The present invention may effectively distinguish such status. The invention may focus on representing the installation and configuration progress of the IO terminals, plants and controllers in a building control domain.

Today's building control systems may integrate different types of systems and devices including HVAC, fire alarms, security systems, lighting and elevators into one computerized system. A high portion of corporate building control projects may include large commercial and industrial building projects such as airports, pharmaceutical firms, and high-rise buildings. These kinds of projects may use a large number of controllers and thousands of the data points to allow central control of multiple plants around the buildings. For an intended use, many controllers may require significant configurations in assigned plants, having inputs and outputs (IO terminals) with customized configuration or programming, which includes time schedules, set-points, logic, timers, data points, trend logs, alarms, and the like. The terminals may include analog inputs (AI), analog outputs (AO), digital inputs (DI), digital outputs (DO), binary inputs (BI), binary outputs (BO), multi-state inputs, multi-state outputs, and so forth. Also, these controllers and points may need to be created, configured, programmed, installed and/or checked out. This appears to be a significant amount of work for the engineers or technicians, and it could be difficult to get an overall view of system status.

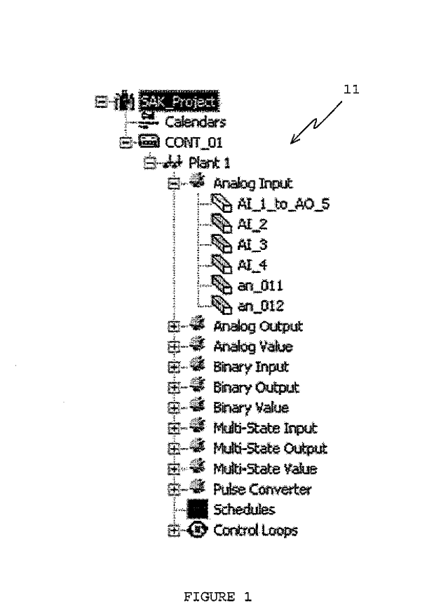

Typically, users may be notified about the status of installing and configuring controllers from a “controllers-plants-IO terminals” hierarchy tree with each status being presented by icons (as illustrated by a tree 11 in FIG. 1). However, several problems appear to exist with the approach of presentation in FIG. 1. First, thousands of controllers and points form a complex hierarchy with long node (e.g., plants and points) list, thus requiring many navigating actions like scrolling and mouse clicking to view the nodes and get into target data points. Also, since the complex hierarchical or non-hierarchical presentation, or large amount data cannot be displayed fully in one screen and requires scrolling navigation, it cannot serve as an overview display, showing, at a glance, the big picture status (which controller, plant and IO terminal, is to be configured or in conflict) and configuring progress (how many controllers, plant and IO terminals have been configured).

Users probably will miss configuring some controllers or points which are hidden from the current view area. It is not necessarily easy to troubleshoot (due to being hidden from the long list) and it appears inefficient (due to much navigating work) for the user to detect the missed, incomplete or wrongly configured controllers or points from the long list.

The matter appears worse when there are multiple users doing the configuration for the same project in parallel, since the configuration status may be updated by multiple users (or is not only updated by a single user).

The present invention may be an effective map view metaphor to facilitate system/controller status and configuration through enhancing overview and quick access. Consequently, the present approach may provide an overview of installation and configuration of all controllers, plants, devices, sensors, IO terminals, and other related hardware and constraints, and help users to easily and efficiently detect the status of the objects which could include not being started or have conflicts. Further, it may allow users to quickly access target objects. The present invention may turn a normal view into a two dimensional map view of the data thus allowing virtually all controllers, plants, devices, sensors, IO terminals, and other related hardware and constraints to be displayed in a fixed space. The map view may permit a user to see all objects in a fixed view at a glance and also provide quick access to the target controllers and points. Also, it appears easy to detect unhandled or improper objects and locate them with the present approach. Users may be constantly aware of the entire installation and configuration process.

The present approaches may provide a view of controllers, plants, devices, sensors, IO terminals, and other related hardware and constraints using color or another kind of coded map views in a fixed space. A first version of the approach may present IO terminals graphically in a form of individual rectangles and grouped by plants and controllers and make the hierarchy or non-hierarchical layout as nested rectangles. A second version of the approach may present the objects in wedges or sectors within a circle. The hierarchical or non-hierarchical information may be laid out radially in such sectors or wedges, moving from the center towards the outer circle. Abnormal IO terminals (e.g., not started or conflicted) may be emphasized by being extended out as outstanding spokes. The number of data points may be represented by a size of rectangle in the first version and the angular sweep of wedge in the second version. Color coding (represented in the Figures with black and white patterns or gray-scale shading) may used to indicate the configuration status—unhandled or not started, in progress, completed, and conflicted. Other status and corresponding types of coding may be used. The conflicted IOs may be distinctively extruded to catch a user's attention. When all IO terminals of a plant are completed correctly, the rectangles representing IO terminals may merge into a one larger resulting rectangle in a respective representative pattern (e.g., dark green). The map view may be clickable to quickly access a target of IO terminals, plants and/or controllers and thus locate, for example, an improper data point. Also, the present approach may be combined with tabular displays. The completion and/or merging may be applicable to other levels of the map, such as plants and even controllers in certain designs.

It may be noted that the present invention and approach may be used for the display of other items or entities besides controllers, plants and terminals. The latter items are utilized for illustrative purposes.

The following are improvements provided by the present approach. This approach may help a user get an overview of the installation and configuration of virtually all controllers, plants and IO terminals at a glance. Since the controllers, plants and IO terminals may be displayed in their entirety on one screen display, there appears to be no controller, plant or IO terminal hidden from user, and there seems to be no need to do any navigation to find an information node. The user may be constantly aware of the entire installation and configuration process. It appears easy to find an unhandled or improper item, and to locate it. The present approach may also provide a quick access to particular targeted controllers, plants and IO terminals.

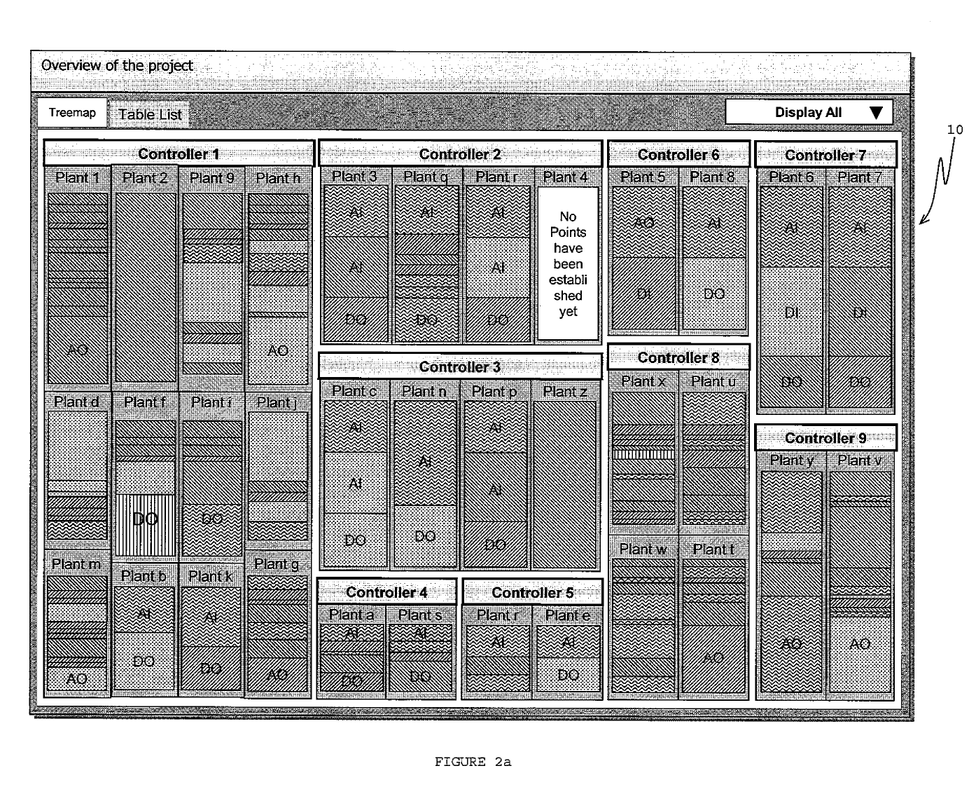

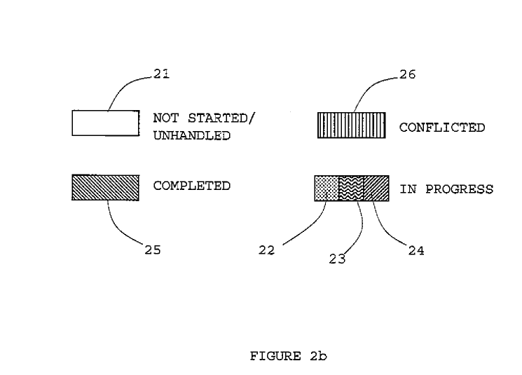

FIG. 2a shows a two-dimensional (2D) display or map 10 in a fixed space. In this Figure, input and output (IO) terminals may be graphically represented in a form of individual rectangles and grouped by plants and controllers in an organized layout with the hierarchical or non-hierarchical arrangement realized as nested rectangles. These rectangles may be regarded as wedges, sectors, areas such as first-, second- and third-tier areas, or first-, second- and third-closed geometric figures. Additionally, there may be fourth-, fifth-, sixth- and higher tier areas. Likewise, these rectangles may be regarded as wedges, sectors, areas such as fourth-, fifth-, sixth- and higher tier areas, or fourth-, fifth-, sixth- and higher closed geometric figures. Or the map 10 or 20 may display just one level tier areas or closed geometric figures representing terminals, points or some other kinds of entities without revealing of any associated hierarchies if there are any.

The Figures of the maps or views 10 and 20 may show color-coding of status; however, it uses black and white patterns in lieu of colors. The colored, shaded, patterned or other coding may represent the configuration status such as not started, in progress, completed, conflicted, or other. During the configuration process, the coding of the graphics may be dynamically updated periodically or in real time. Also, information of the map 10 or 20 may be saved and recalled later for viewing and analysis.

FIG. 2b shows a legend which reveals a coding with black and white graphic patterns representing various colors. In FIGS. 2a, 3, 4, 5 and 7, the graphics 21, 22, 23, 24, 25 and 26 may represent “not started/unhandled”, three levels of “in progress”, “completed”, and “conflicted”, respectively. There may be more or less than three levels or stages of progress. Even though the actual choice of colors in the Figures may vary according to application or preference, graphic patterns 21, 22, 23, 24, 25 and 26 may be incorporated here to represent white, dark orange, light orange, light green, dark green and red, respectively. Other color choices may be implemented instead, or one may use other graphic patterns or shading. Additional status representations may be incorporated.

When all of the IO terminals of a plant, such as plant 2, are completed, rectangles representing all IO terminals may merge to big rectangle having a graphic pattern 25, or dark green if shown in color, as indicated by an arrow 31. Even if only one IO terminal, as indicated by an arrow 32, is uncompleted, then the rectangles will not merge together into one rectangle relative to plant 1. Through this method, it may be easier for users to detect the completed status. When there appear to be too many points in one rectangle, and when most of these points are completed, then the rectangle looks pretty much (e.g., 98 percent) dark green, or other color, shading or pattern appearing to designate a completion. Thus, the user may wrongly think that this rectangular is completed. However, using the present merging together approach, the user should never get confused in this way. The user may always be aware that there are one or more points not completed since the rectangle is not merged. The completion and merging may be applicable to levels higher than that of the points of a map.

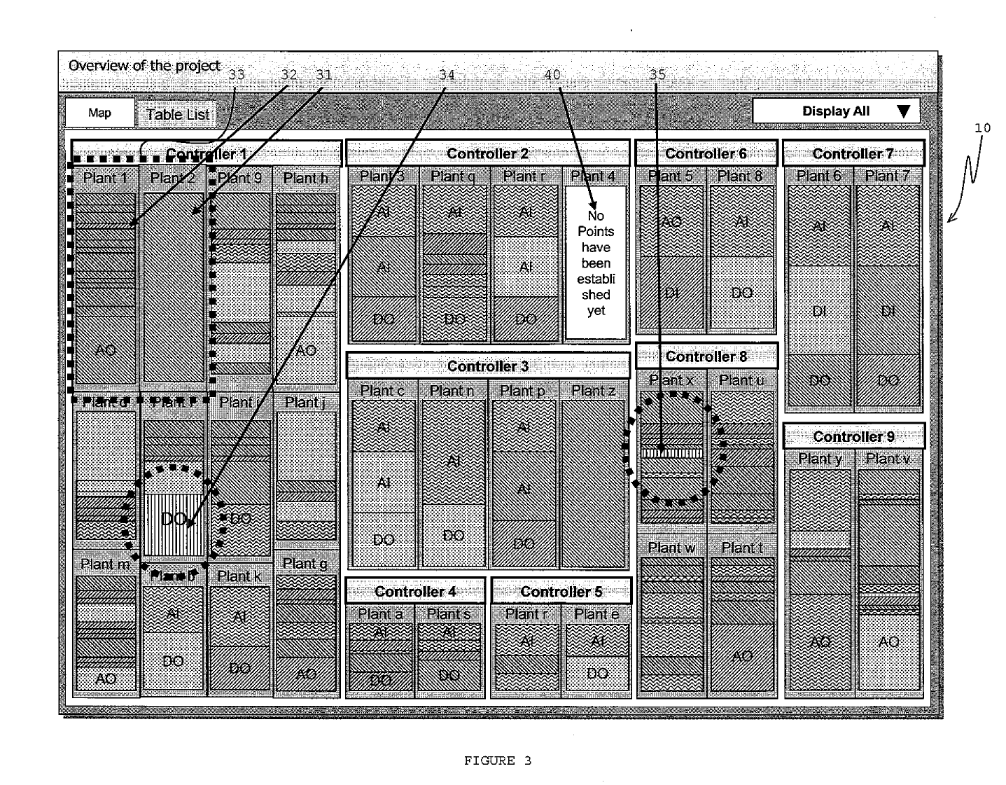

In addition to graphic or color coding of status, the present approach may also provide certain techniques to distinguish an important status or change of status, such as merging together or conflict, with flickering and filtering as examples. One may look at plants 1 and 2 under controller 1 as delineated by a dashed rectangle 33 in FIG. 3.

Conflicting by terminals may be indicated by a graphic pattern 26 or a corresponding color such as red. Examples include an IO terminal in plant f of controller 1 and a terminal in plant x of controller 8 as indicated by arrows 34 and 35, respectively, in FIG. 3. The conflicting IO terminals may flicker to catch a user's attention, whether in a graphic pattern, shading or color. Plant 4 of controller 2 has no IO terminals since no data points or amount of effort 40 has been established or developed yet for the plant. Plants and controllers may instead or also flicker to indicate conflicts or other factors.

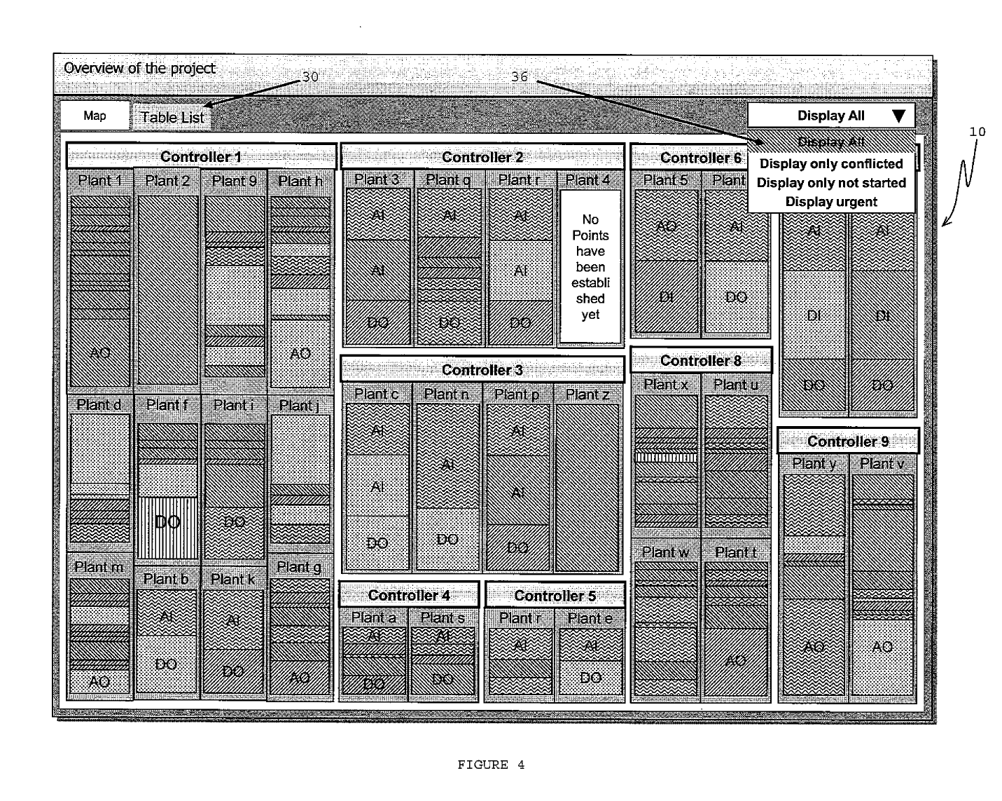

The IO terminals may be filtered through a drop-down menu 36 as shown in FIG. 4. One may also filter with other approaches. For example, one may right click one pattern and then the system can show a couple of options, e.g., “display only conflicted”, “display only similar status”, “display only similar points”, and so forth. One of the options may be clicked to filter the points. Filtering by the menu may result in a display of only conflicted terminals, only terminals not started, or urgent terminals. Filtered points may be distinctively displayed, such as in one case, they may be distinctively displayed in the map view, and in another case, only conflicted points may be displayed as a table, and so on. The menu 36 may also be designed to display terminals of a certain stage of progress, such as one or more of the three stages represented by the graphic patterns 22, 23 and 24 in FIG. 2b. Also more or less three stages of terminal progress may be represented by graphic patterns, shades or colors. Menu 36 may further be set to display only or just recently completed IO terminals. Clicking on the table list label 30 at the upper left of the map 10 display may reveal a list of tables, data or other information associated with the map.

Efforts representation may be shown by the present approach. For instance, the number of data points may be represented by the size of each rectangle to thus show an amount of effort needed for a configuration of the respective IO terminal. Or the size of the rectangle or other representative figure may indicate an amount person effort needed to configure the data points.

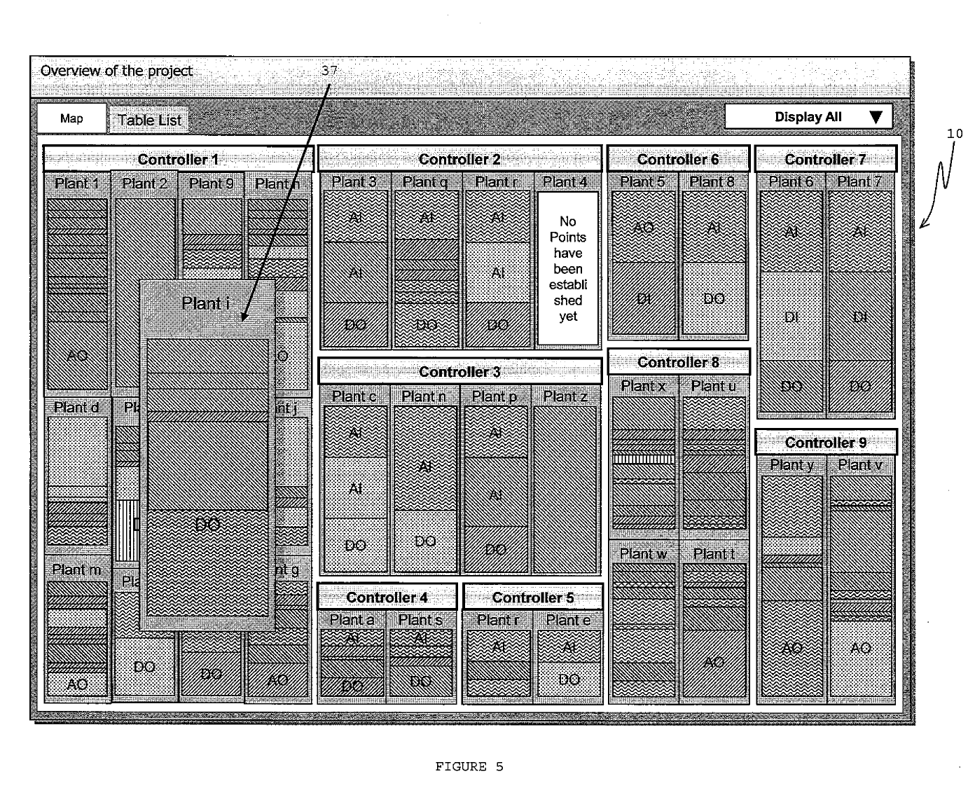

FIG. 5 shows a scalable view and quick access scheme. The map 10 view may be clickable to quickly access target IO terminals, plants and controllers, for example, to find and locate an improper data point or a proper data point. One may popup an enlarged map 37 of, such as for example, a plant i. One may also click on the pop-up map 37 to access and view details of a target object. Using a mouse click or hover the map might provide some tips to explain the target object.

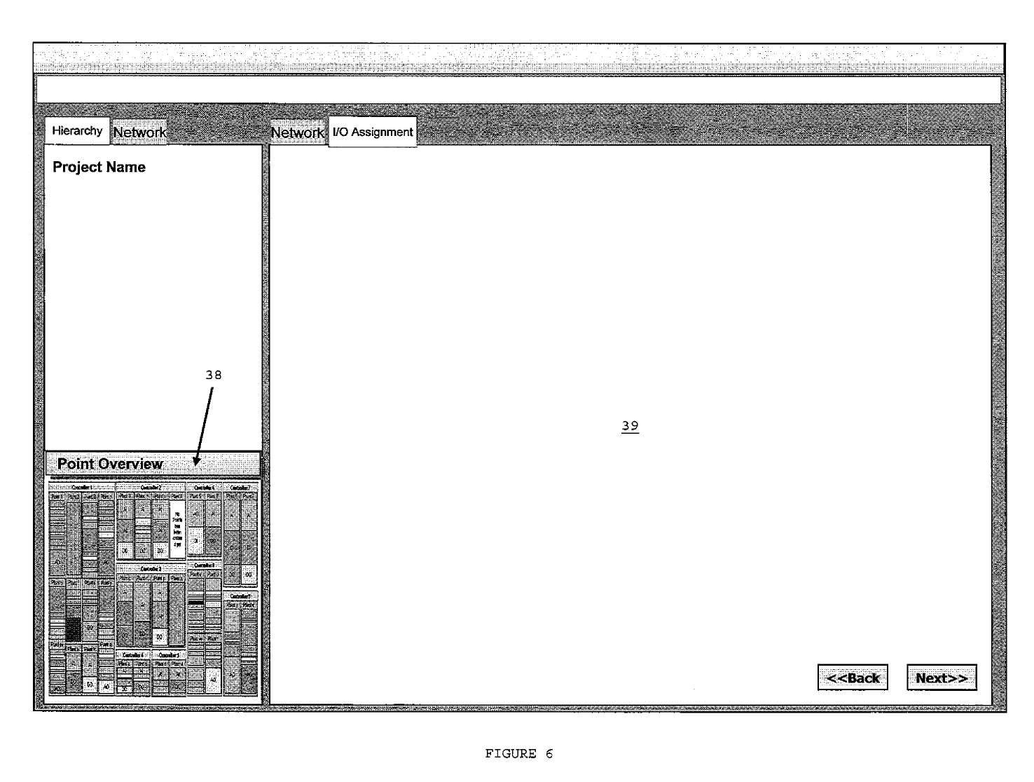

FIG. 6 shows where the map 10 may become a miniaturized view 38 in a layout with other information of, for instance, a related project or program in space 39. The map view may be enlarged. One may double click to popup a whole full-sized window map view. One may click or hover to enlarge target area like using a fisheye approach, magnifier or magnifier metaphor.

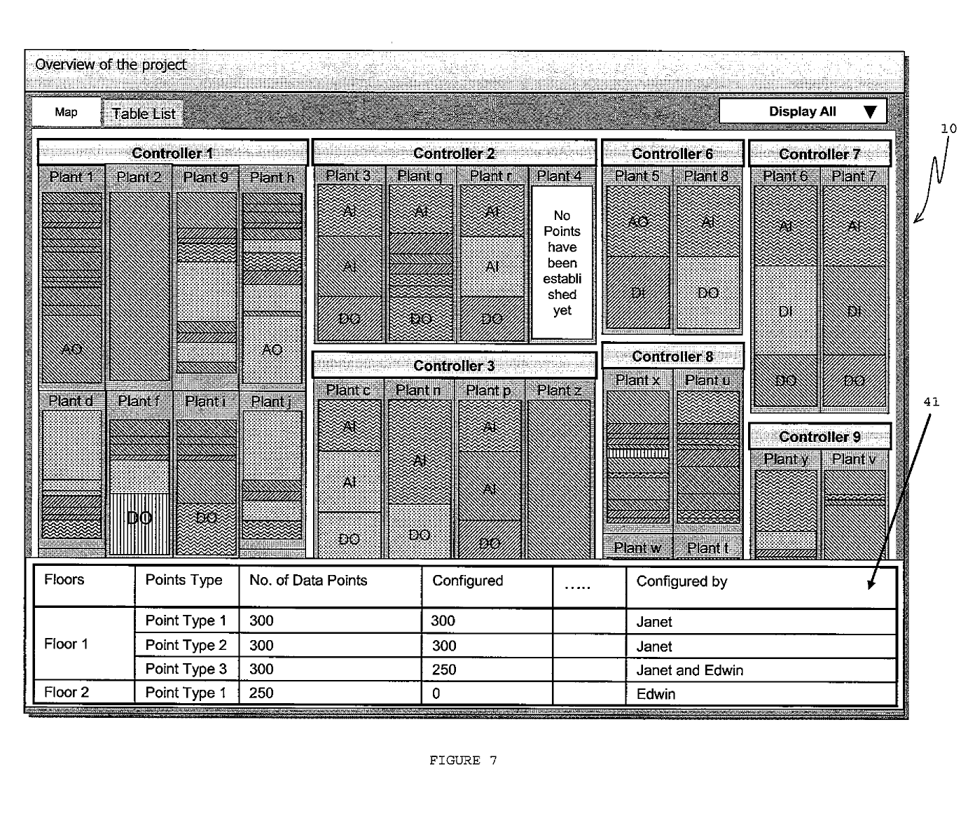

FIG. 7 shows where one may also integrate the map 10 overview with a tabular view 41 of data, such as data points, relative perhaps to a particular controller and a constituent plant layout. The view 41 may also reveal floors of a plant, type of plant, type of points, the number of points configured and who configured them. Other information may be included in the tabular view.

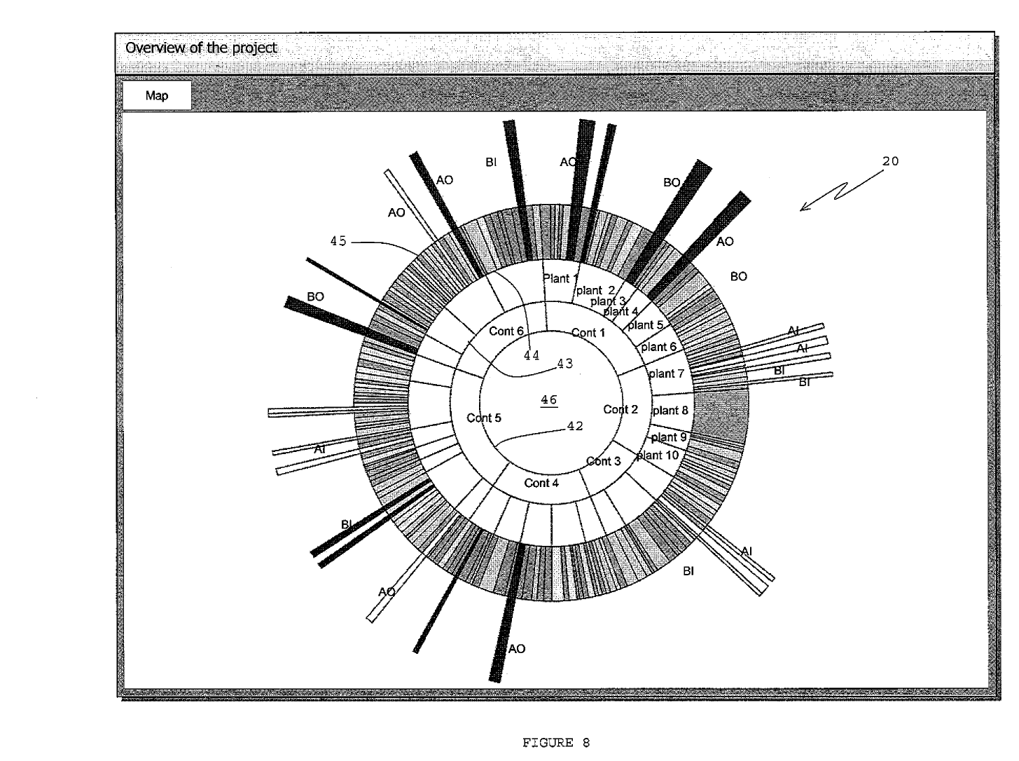

FIG. 8 shows a radial map 20 that fills a fixed space. The controllers, plants, IO terminals and notable IO terminals (e.g., not started, conflicted, or other selected terminals) are four concentric circles 42, 43, 44 and 45, respectively. The circle of controllers is the nearest to the center 46 and the circle of notable IO terminals may be beyond circle 45 and the farthest one from the center. The controllers, plants and terminals may be moved in one circle closer to the center with the inner most circle 42 being sectored to the center 46 for the controllers, the sectors in the area between circles 42 and 43 being sub-sectored for plants, and the sub-sectors between circles 43 and 44 being sub-sectored for the terminals. There may be more or less groups or circles for delineating controllers, plants and terminals, or other hierarchies or non-hierarchical arrangements of items. The map 20 may instead reveal one level of entities, such as points or terminals, without revealing a hierarchy. Other levels may be exclusively displayed.

Graphic patterns as shown in FIG. 2b may be used to represent a configuration status, such as not started/unhandled, in progress, completed, conflicted, and other categories, for the second version of the present approach. The graphic patterns used in FIGS. 2a, 3, 4, 5 and 7, may be similarly applied to the circular maps 20 of FIGS. 8-12, although shading is presently used in the latter Figures. During a configuration process, the color-coding, graphic patterns or shading of the map may be dynamically updated periodically or in real time. Also, such information may be stored and recalled later for analytical purposes.

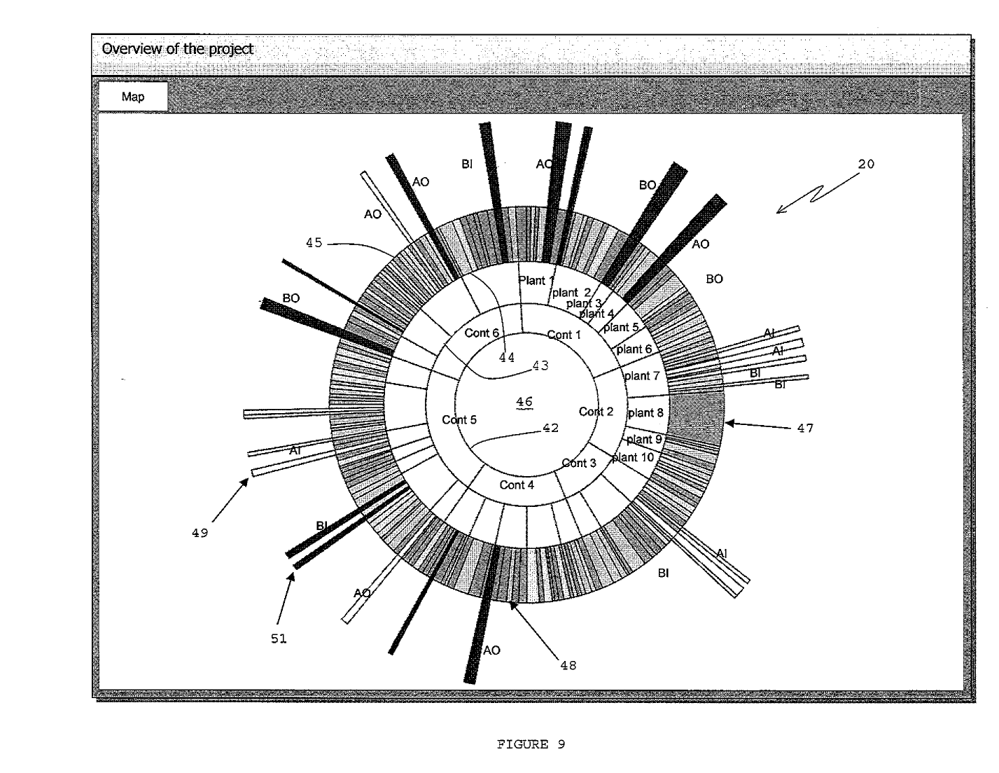

Besides coding of status, the map as illustrated in FIG. 9 may also have various techniques for distinguishing one or more instances of an important status, such as merging together or conflicts. The techniques may include flickering and extruding. When all of the IO terminals of a plant are completed, pie-like sectors, wedges or rectangles representing all IO terminals of a plant may merge into one large sector, wedge or rectangle of a color or graphic indicating completion, as shown by arrow 47. However, if there is only one IO terminal uncompleted, as shown by arrow 48, the sectors or rectangles will not merge together for that plant. The not-started or unhandled IO terminals may extend out to catch a user's attention, as illustrated by an example indicated by arrow 49. Also, the conflicted IO terminals may also extend out to catch the user's attention, as indicated by arrow 51. Merging and/or conflicting, along with the respective indicators, may occur at higher levels such as those representing, for example, plants and controllers.

As to an efforts representation, the number of data points (e.g., effort for configuration) may be represented by an amount of angular sweep of each wedge, sector or rectangle, of the circular map 20 in FIGS. 8-12.

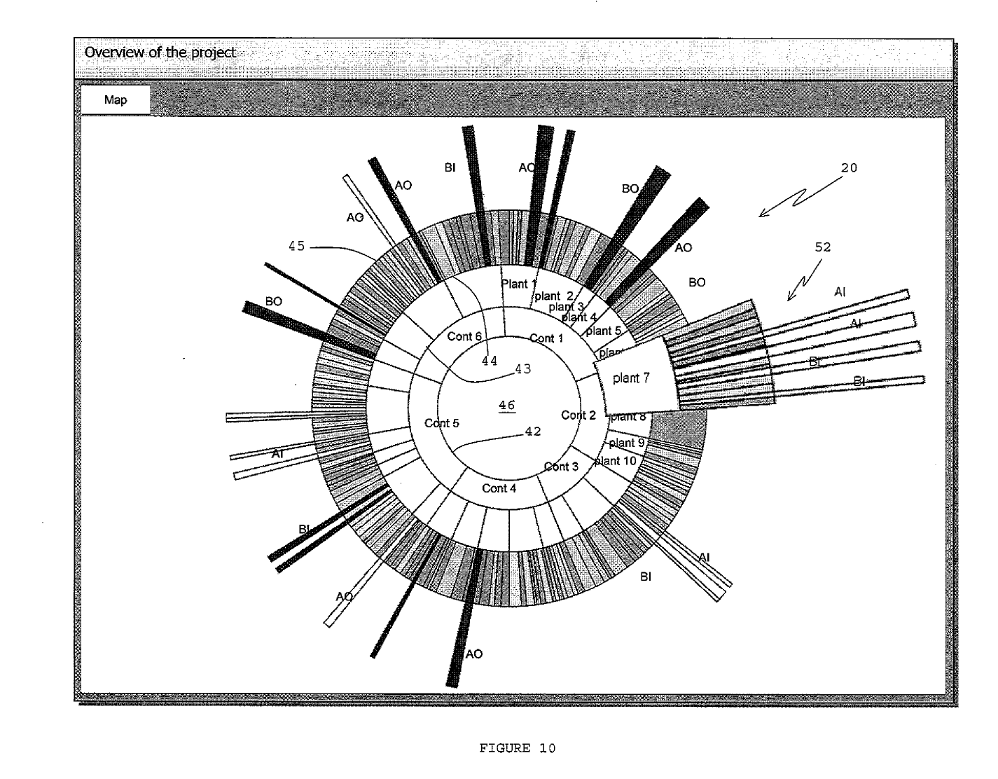

FIG. 10 is a diagram of a map 20 for a display on which can be clicked with a mouse or the like for scalable and quick access of specific target IO terminals, plants and controllers, for instance, to locate improper or proper data points. One may pull or popup an enlarged map 52 by clicking on the portion or plant desired for closer review. One may also click on the pop-up map 52 to for closer review, examination and/or an access of information within the popped-up area.

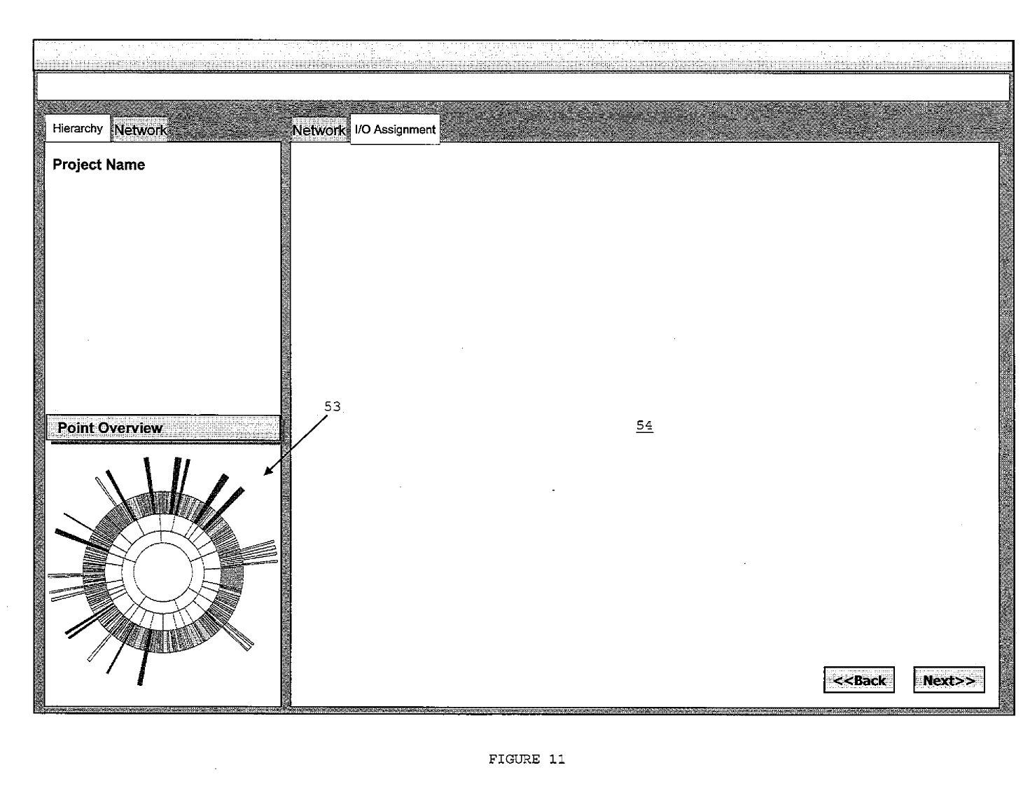

FIG. 11 shows where the map 20 may be a miniaturized view 53 in a layout with space 54 for other information of, for instance, a related project or program. The map view may be enlarged. One may double click to popup a whole window map view. One may click on or hover to enlarge a target area like using fisheye method or magnifier.

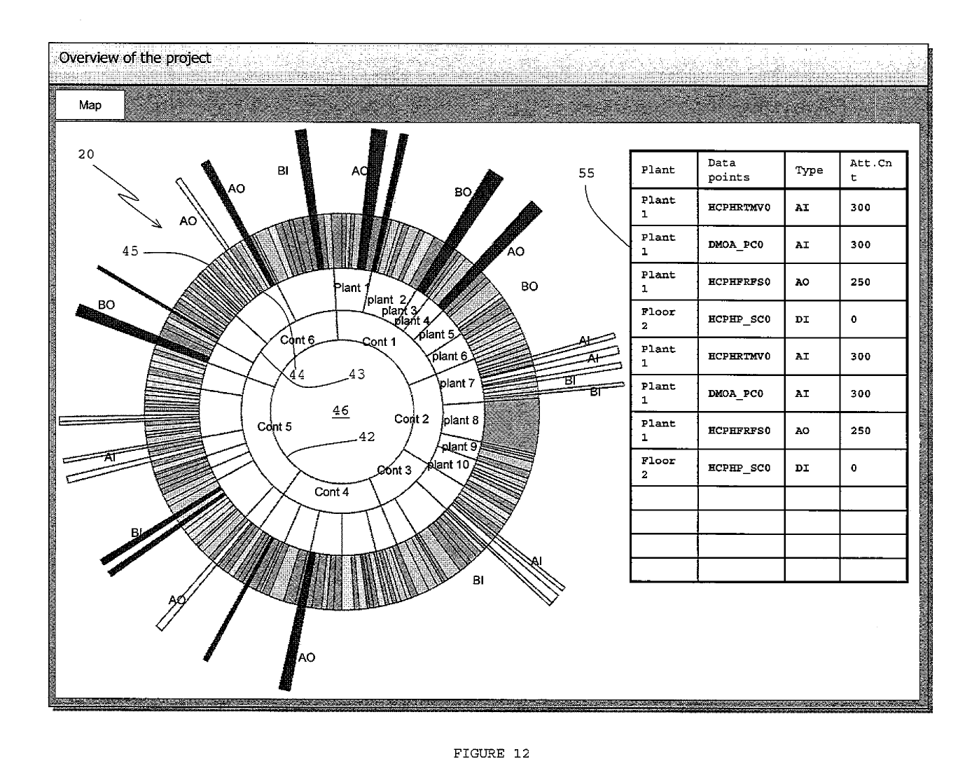

FIG. 12 shows where one may also integrate the map 20 overview with a tabular view 55 of data, perhaps relative to the controller and plant layouts. The plant, floor, data points, type of terminal, and other information may be presented in view 55.

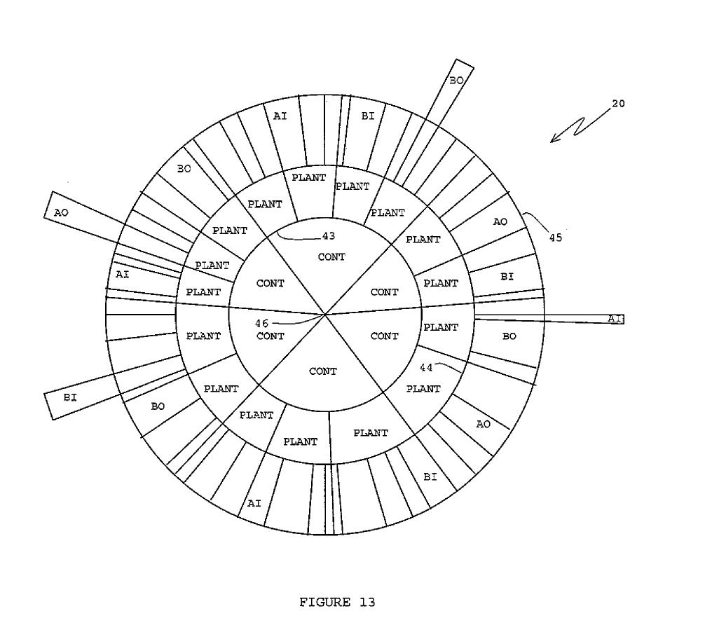

FIG. 13 is a diagram of a radial map 20 with just three concentric circles 43, 44 and 45 rather than the four shown in some of the other radial maps 20 described herein. For illustrative purposes, the color, shading and pattern graphics were not added, although may be utilized or added, to the map 20 of FIG. 13. Various other configurations of map 20 may be implemented relative to the present approach.

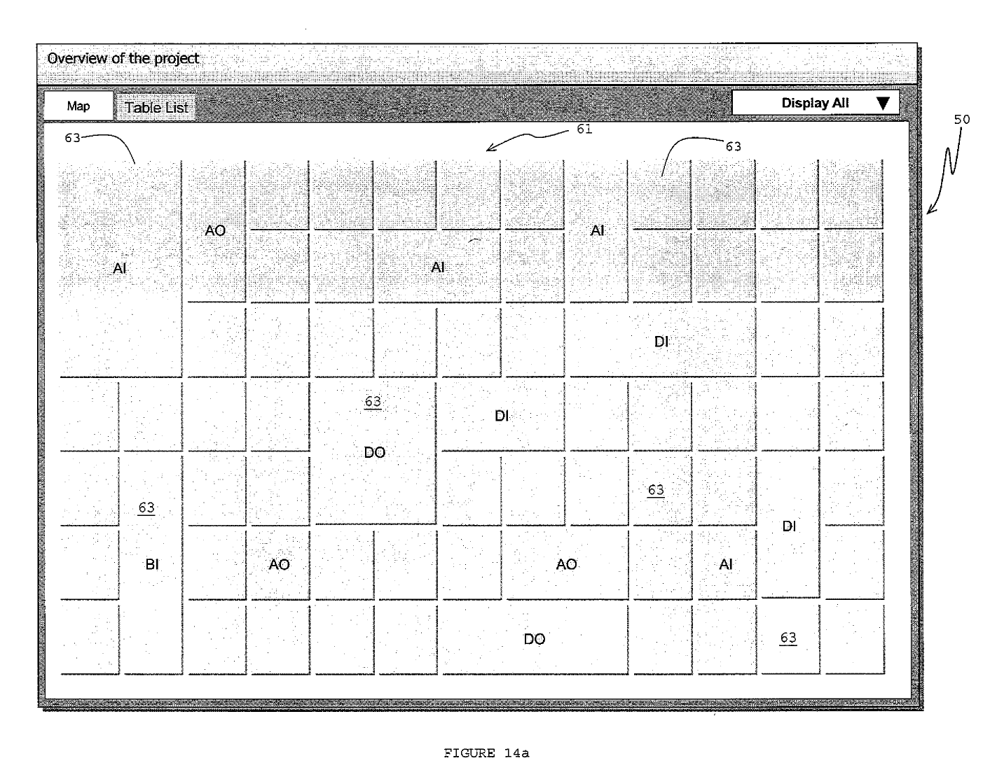

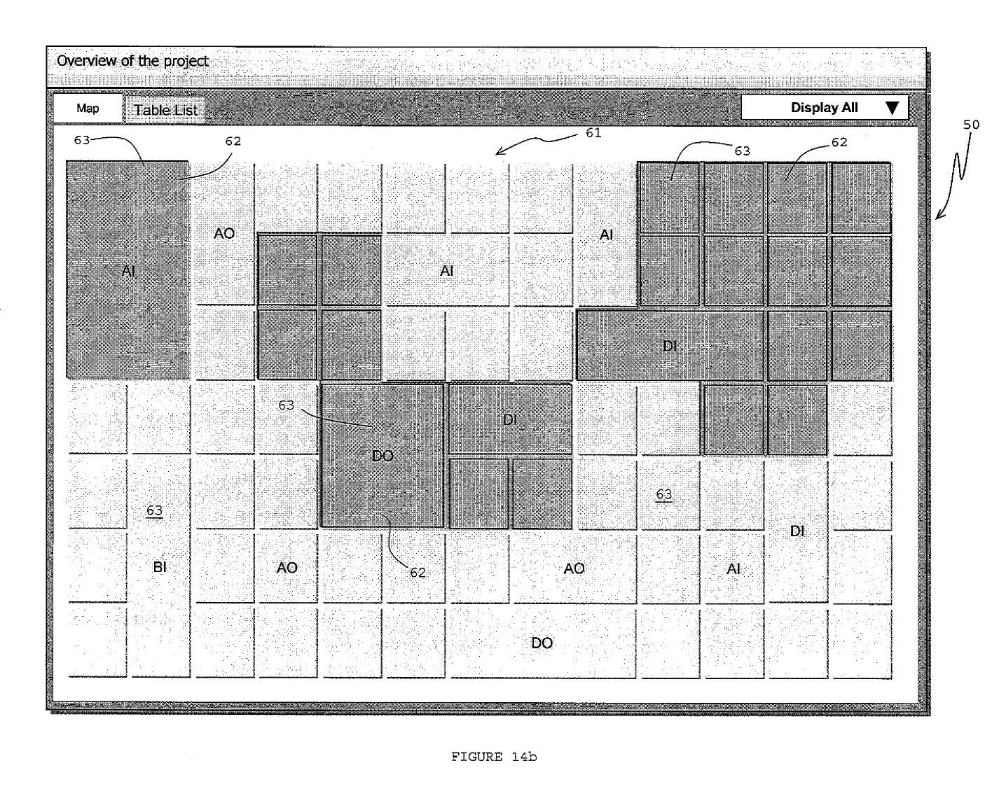

The present approach may also apply to just a point level version of the map. It may be just a map view of all points of a project. Each point can be a rectangle or other shape. A user does not need to know the hierarchical structure behind the points. Also, the user does not need to know which points belong to which controller. One may just open a map view of all points. Each rectangle or other shape may represent a point. One may click the rectangle or shape to configure the point. FIGS. 14a and 14b reveal the noted map view metaphor.

In view of FIG. 14a, one may display an all points level 61 in a map view 50. Sometimes users do not need to know the hierarchical structure and thus would not be revealed in the map view 50. The size of each rectangle 63 may indicate the time efforts needed for configuring or completion of the points within the respective rectangle. The rectangles 63 may be regarded as closed geometrical figures. These geometrical figures may instead be squares, triangles, circles, or other shapes.

In view of FIG. 14b, all of the completed points 62 of the respective rectangles 63 of the points level 61 may be distinctively displayed and merged together in map view 50. Here, one may adopt a “Minesweeper” metaphor to distinctively display completed points 63. Also, one may use color coding, pattern coding, flickering, shading, and other distinguishing mechanisms in the map.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A map comprising:
a plurality of first-tier areas; and
wherein:
each first-tier area comprises a plurality of second-tier areas;
each second-tier area comprises a plurality of third-tier areas; and
each tier area comprises an indicator of a status.

2. The map of claim 1, wherein virtually all of the third-tier areas are displayable at the same time.

3. The map of claim 1, wherein:
a first tier area represents a controller;
a second tier area represents a plant; and
a third tier area represents a terminal.

4. The map of claim 1, further comprising a filter for displaying first, second and/or third-tier areas having a selected status.

5. The map of claim 1, wherein a status denotes not started, unhandled, in progress, completed, conflicted, urgent, or another state of a third-tier, second-tier and/or first tier area.

6. The map of claim 1, wherein a status is provided by a color, graphic pattern, shading, flickering and/or indicating mechanism of a third-tier, second-tier and/or first-tier area.

7. The map of claim 1, wherein the first-tier areas, second-tier areas and/or third-tier areas are of a rectangular, triangular, circular or other form.

8. The map of claim 1, further comprising:
a first circle having a center;
a second circle approximately concentric to the first circle; and
a third circle approximately concentric to the first circle; and
wherein:
the first circle has a first area;
the second circle has a second area;
the third circle has a third area;
the third area is greater than the second area;
the second area is greater than the first area;
the third area minus the second area designates the third-tier areas;
the second area minus the first area designates the second-tier areas; and
the first area designates the first-tier areas.

9. The map of claim 8, wherein:
the third-tier areas are sectors of the third circle;
the second-tier areas are sectors of the second circle; and
the first-tier areas are sectors of the first circle.

10. The map of claim 9, wherein selected third-tier areas are extendable beyond the third circle for observation.

11. The map of claim 8, wherein:
if all third-tier areas achieve a certain status, then the third-tier areas may blend together as a second-tier area incorporating the third-tier areas;
if all second-tier areas achieve a certain status, then the second-tier areas may blend together as a first-tier area incorporating the second-tier areas.

12. The map of claim 8, further comprising a tabular information display proximate to the map.

13. The map of claim 8, wherein a size of a third-tier area indicates a number of data points for the area or man effort needed to configure the data points.

14. A method for providing a map, comprising:
providing a display area;
dividing the display area into a plurality of controller areas;
each controller area comprises one or more plant areas; and
each plant area comprises one or more terminal areas.

15. The method of claim 14, further comprising:
providing a legend for status;
status is not started, unhandled, in progress, completed, conflicted, urgent, or another state of a terminal or plant area; and
status is provided by a graphical pattern, color, shading, flickering, or other display indication in a terminal, plant and/or controller area.

16. The method of claim 15, further comprising:
providing a filter for displaying virtually only areas having a certain one or more status;
providing a mechanism for enlarging an area of the map; and
providing a tabular information view proximate to the map; and
wherein:
virtually all areas are viewable simultaneously on the map; and
the size of a terminal area is indicative of an amount of effort needed for configuring the terminal represented by the terminal area.

17. A two-dimensional map comprising:
one or more first-level closed geometric figures; and
wherein virtually all of the one or more first-level points are displayed in a one level map view.

18. The map of claim 17, wherein a size of a first-level geometrical figure indicates an amount of time effort required for completed points of the respective first-level geometrical figure.

19. The map of claim 18, wherein:
the completed points are distinctively displayed relative to other points in the map view; and
the completed points may merge.

20. The map of claim 17, further comprising:
one or more second-level closed geometric figures; and
wherein:
one or more first-level closed geometric figures are situated within nearly each of the one or more second-level closed geometric figures;
each of the one or more first-level closed geometric figures has a status indicator; and
a size of each of the one or more first-level closed geometric figures is proportional to a configuration effort.

21. The map of claim 17, further comprising:
one or more third-level closed geometric figures; and
wherein:
one or more second-level closed geometric figures are situated within nearly each of the one or more third-level closed geometric figures; and
virtually all of the one or more first-level closed geometric figures can be displayed at the same time on the map.

22. The map of claim 18, wherein:
a closed geometric figure has a shape of a rectangle, circle, triangle, or the like;
the one or more second-level closed geometric figures represent a first kind of items;
the one or more third-level closed geometric figures represent a second kind of items;
the status indicator is a graphical pattern, color, shade, flicker, or other mechanism in a closed geometric figure; and
the map is two-dimensional presentation.

23. The map of claim 22, further comprising:
one or more higher-level closed geometric figures; and
wherein:
the one or more higher-level closed geometric figures represent a higher kind of items;
higher-level means a level greater than a third-level; and
higher kind means greater than a second kind.
